(19) United States
(12) Patent Application Publication
(10) Pub. No.: US 2004/0153432 A1
(43) Pub. Date: Aug. 5, 2004

(54) Method and system for outputting an analyzed data report

(76) Inventors: Charles R O'Halloran, Wheaton, IL (US); Janette M Glasser, Glen Ellyn, IL (US)

Correspondence Address: Charles C Valauskas, Baniak Pine & Gannon, Suite 1200, 150 North Wacker Drive, Chicago, IL, 60606-1606, US

(21) Appl. No.: 10/433,147

(22) PCT Filed: Sep. 26, 2001
(86) PCT No.: PCT/US01/30082

(51) Int. Cl. G06F 17/30

(52) U.S. Cl. 707/1

(57) ABSTRACT

A method for outputting an analyzed data report including receiving a request (100), accessing a database (105), collecting data (110), analyzing data (115), creating a report (120) and outputting the report (125) to an end user.

### FIELD OF THE INVENTION

The present invention relates to searching systems that output reports, and, more particularly, to a searching method and system for outputting an analyzed data report based on a search and analysis of a database of records.

### BACKGROUND OF THE INVENTION

In today's world, information is key. As a result, the ability to obtain and process information has very often made the difference between a successful entity and an unsuccessful one. Given the incentive, business entities as well as individuals have sought not only to obtain and process information but also to obtain and process information more quickly and more accurately than one's competitor; this also has the added benefit of saving valuable time and energy.

Within the general desire to obtain and process information are specific interests of various entities as well as individuals to obtain additional information regarding very specific areas information. For example, there are specific interests to search for titles of motor vehicles and items of personal property that have titles, professional licenses such as medical licenses and bar certifications, and other similar arenas. One of the more important arenas in which members of the general public, as well as industry professionals, at one time or another require a search for information concerns documents recorded against parcels of real property, and, more specifically, whether those parcels contain liens, encumbrances or unrelated mortgages.

At the present time, there are many users requiring access to real property-related data. Counties (or other governmental entities) throughout the United States maintain this data either in paper for or semi-automated form. Users require not only access to this data, but the analysis of it as well, in order to make critical business decisions on a daily basis. As a result, there currently exists a large demand to obtain information regarding real estate. The collection and analysis of real property data may be used for multiple purposes, the most important of which is to provide a legal means to protect the interests of land owners and lien holders by notifying all creditors, subsequent purchasers and others with an economic interest in a parcel of real property about the ownership and encumbrances against that parcel.

Currently, there are multiple indexing systems in place in Recording Offices across the Country. Each State has enacted statutes that provide the methods for the indexing, sorting, searching, and presentation of real-estate related information to an end user 230. Despite the demand and legal authorization to do, the quality of these systems will largely depend upon the size (i.e., population) of a county and the funds they have available to automate these systems. These differences, along with other localized issues, make the concept of centralizing all of this indexed real estate data into one uniform, universal tracking system both unrealistic and unnecessary.

While a universal tracking system concept might be applicable to personal property, such as, motor vehicles, boats, antiques and the likes, personal property is movable and can be transferred across State lines, as well as overseas. Real estate, by contrast, is immovable. The need for tracking real estate via a dependable universal system is virtually non-existent. The inhabitants move in and out of the real estate, while the real estate itself stays fixed.

A demand therefore exists for a system by which real-estate data obtained from various databases such as those compiled by local jurisdictions having the legal obligation to compile and maintain real estate-related records may be accessed and a report prepared that provides the information in a format selected by the end user 230. The present invention satisfies the demand.

### SUMMARY OF THE INVENTION

The system of the present invention takes into account the various differences between the above-noted differing methods of recordation and translates those differences into a common output. More specifically, once the system of the present invention is programmed for the terminology specific to a particular locale, as well as the procedures by which an end user 230 navigates through its computerized indexing system, it follows a predetermined set of rules to collect, analyze and display the data in a format selected by an end user 230.

It is therefore an object of the present invention to provide a method for outputting an analyzed data report. A request signal is received. The request signal includes a request for an analyzed data report of a parcel of real property. A database of records is accessed. The database of records relates to the parcel of real property. Data is collected from the database of records. The collected data is then analyzed. An analyzed data report is created from the analysis of the collected data. Finally, the analyzed data report is outputted to an end user.

It is a further object of the present invention to provide a system for outputting an analyzed data report. A request signal is received. The request signal includes a request for an analyzed data report of a parcel of real property. A database of records is accessed. The database of records relates to the parcel of real property. Data is collected from the database of records. The collected data is then analyzed. An analyzed data report is created from the analysis of the collected data. Finally, the analyzed data report is outputted to an end user.

### BRIEF DESCRIPTION OF THE DRAWINGS

FIG. 1 illustrates a top level flowchart of a preferred embodiment of the present invention of a method and system for outputting an analyzed data report, made in accordance with the present invention; and

FIG. 2 illustrates a block diagram of the elements in the preferred embodiment of FIG. 1.

### DETAILED DESCRIPTION OF THE PRESENTLY-PREFERRED EMBODIMENTS

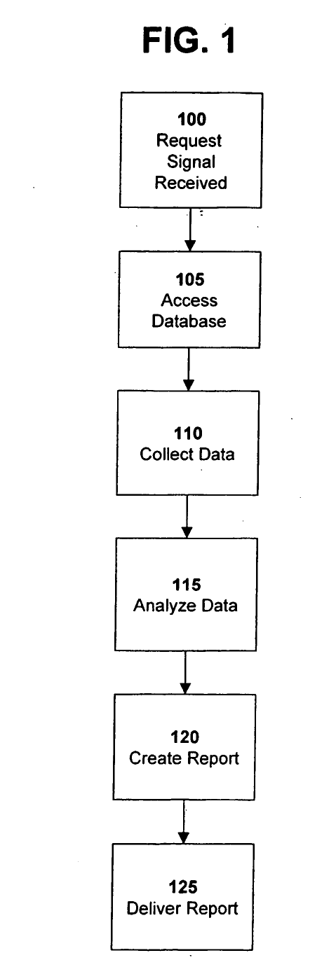

FIG. 1 illustrates a flow chart of a preferred embodiment of the present invention which is directed to a method and system for outputting an analyzed data report. Although the example illustrated in FIG. 1 relates to an analyzed data report concerning parcels of real property, the example is merely that; an example. It will be understood that the embodiment disclosed and illustrated herein may be modified appropriately for use with other information such as County clerk data, Circuit clerk data, State's attorney data to provide an analyzed data report having the information and format selected by the end user 230.

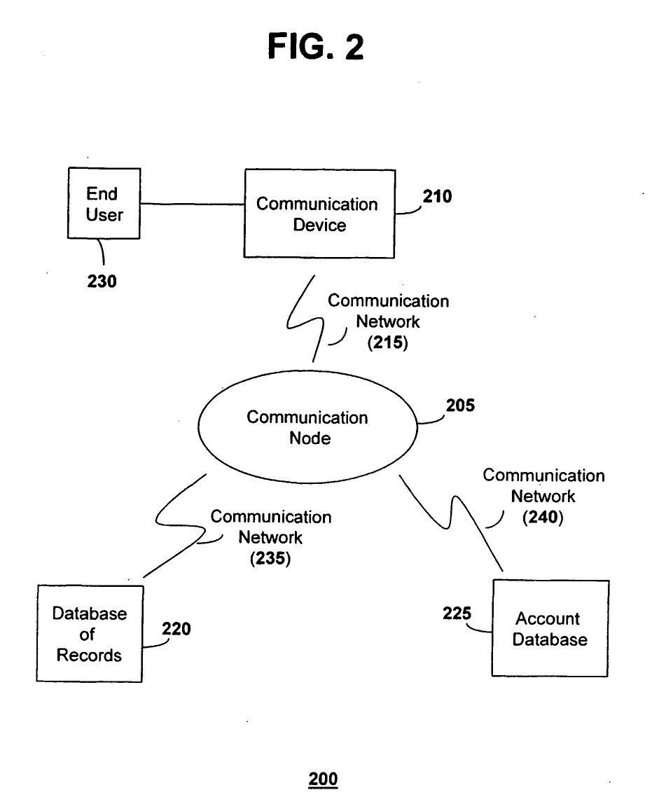

FIG. 2 illustrates a block diagram showing the elements that may be utilized to effect and realize the preferred embodiment of the method and system illustrated in FIG. 1. The elements illustrated in FIG. 2 are merely exemplary and are not in any requirements of the present invention.

As illustrated in Step 100 of FIG. 1, the process of outputting an analyzed data report begins with a request by a party (termed also “end user” herein) for information regarding a particular parcel of real property. Preferably, the request is transmitted as an electronic signal from an electronic communication device 210 and received at an electronic communication node 205. Moreover, the request signal is transmitted across an electronic communication network 215.

The electronic communication device 210, as used in the system 200 of the present invention, may be utilized by an end user 230 (which may enter into the system as a subscriber) to access and/or connect with the electronic communication node 205. The electronic communication device 210 can include, without limitation, wireline telephones, paging units, radio units, wireless data devices, portable, mobile or wireless telephones, personal information managers (PIMs), personal digital assistants (PDAs), personal computers (PCs), network televisions (TVs), Internet TVs, Internet telephones, portable wireless devices (i.e., two-way pagers), workstations or any other suitable communication devices.

Regardless of its specific form, the electronic communication device 210 may have a user-input interface and/or a user-output interface. Alternatively, the user-input interface and/or the user-output interface may work in conjunction with the electronic communication device 210 without actually residing on the electronic communication device 210.

The user-input interface may receive input from the end user 230 and the user-output interfaces may provide output to the end user 230. The user-input interface can include, without limitation, an electroacoustic transducer, such as, for example, a microphone to receive voice and other audible input from the end user 230, a keypad or a keyboard to receive key strokes from the end user 230, a touchpad or touchscreen to receive touch input from the end user 230, a handwriting recognition interface to receive handwritten input from the end user 230 or a pointing device such as, for example, a mouse or a trackball to receive point and click inputs from the end user 230.

Similarly, the user-output interface of the electronic communication device 210 can include, without limitation, an electroacoustic transducer such as, for example, a speaker to provide voice and other audible output to the end user 230, and a visual display device such as a liquid crystal display or a cathode ray tube to provide graphical and/or textual information to the end user 230.

The electronic communication device 210 may include more than one user-input interface and/or more than one user-output interface. Moreover, the end user 230 may utilize one or more user-input interface and/or user-output interface simultaneously. For example, a wireless telephone may have a microphone, a telephone keypad, a speaker, and a visual display device.

An input interface may also reside on the electronic communication node 205. An output interface may also reside on the electronic communication node 205. Alternatively, the input interface may reside on the electronic communication node 205 while the output interface may reside on the electronic communication device 210. Alternatively, the input interface may reside on the electronic communication device 210 while the output interface may reside on the electronic communication node 205.

The electronic communication device 210 may also communicate with an electronic communication node 205 via the electronic communication network 215. The electronic communication network 215 can interface with the electronic communication device 210 through wireline or wireless networks or systems (i.e., telephone or televisions systems, Integrated Services Digital Network (ISDN) systems, coaxial lines, computer networks, digital end user lines, private networks, wireless local loop systems, etc.).

The electronic communication networks 215, 235, 240 of the system 200 can include, without limitation, intranets, extranets, the Internet, a Local Area Network (LAN), a telephone network, (e.g., a Public Switched Telephone Network (PSTN), private telephone networks, etc.), a cellular network, satellite networks, a personal communication system, a TV network (e.g., a cable TV system), local, regional, national or global paging networks, an email system, a wireless data network (e.g., satellite data or local wireless data networks), a wireless LAN, a wireless local loop/distribution system (e.g., LMDS, MMDS or Code Division Multiple Access (CDMA) based system), a Voice Over Internet Protocol (VoIP) network or any other suitable network. The electronic communication networks 215, 235, 240 may also include a wide area network (WAN), such as, for example, the Internet, the World Wide Web (WWW) or any other similar on-line service. It will be recognized that the electronic communication networks 215, 235, 240 may have portions in common, may comprise a separate network, or may be the same network as a second electronic communication network.

Additionally, the end user 230 may be required to input a security-type code or signal to enter the system 200. For example, the security-type code or signal may comprise, without limitation, a password, a personal identification number (PIN), a keycode, a subscription code or any other type of security code or signal.

The electronic communication node 205 is preferably a location from which an embodiment of the method and system of the present invention may be run. The electronic communication node 205 may preferably be, without limitation, a PC, a TV, a telephone, a personal communication system, local, regional, national or global paging networks or any other suitable network. Additionally, the electronic communication node 205 should interface properly with the electronic communication device 210 and the electronic communication network. For example, if the electronic communication network is the Internet, and the electronic communication device 210 is a PC, then the electronic communication node 205 should be compatible with the PC (i.e., run off Hyper Text Markup Language (HTML)).

After the request signal has been received, as illustrated in Step 105, the electronic communication node 205 then accesses a database of records 220. Preferably, the database of records 220 corresponds to a listing of parcels of real property, and may include, without limitation, a county-wide (or other jurisdiction-wide) listing of parcels located within the county, as well as any private entities which maintain a collection or database of the information recorded within the Governmental entity.

For instance, the preferred embodiment may be utilized to access and analyze both State-based (i.e., County, State or other Governmental entity) or other private entities that also maintain a listing of real property-related records. Moreover, the listing of parcels may be organized in one of a number of formats. Preferably, these formats may include, for example and without limitation, a Permanent Index Number-based method (in which the end user 230 must provide that Index Number to access the data, a legal description-based method (in which the listing is according to the legal description (i.e., Lot, Block, Subdivision or Metes and Bounds description) of the parcels of real property), or a Grantor/Grantee-based method (in which the listing is organized in two ways—one according to the grantor of any transfer of the parcel, and one according to the grantee of any transfer of the parcel).

The database of records contains a listing of real estate-related information. In FIG. 2, it is illustrated as reference numeral 220, and although it is shown as being remote from electronic communication node 205 (Via electronic communication network 235), it should be understood that the database 220 may alternatively be located integral with the electronic communication node 220. Preferably, the listing of real estate-related information includes a reference, or legal description, of each parcel of real property. The legal description is a means for describing the location of the parcel. It may be by Metes and Bounds, a Permanent Index Number, a reference to Lots, Blocks or Subdivisions or any other suitable sorting method.

As different jurisdictions organize their files differently, it is imperative for time-conserving reasons, that the electronic communication node 205 be capable of determining the method of indexing prior to collecting data from the database of records 220. Such information may be manually transmitted to the electronic communication node 205, such as, for example, inputted into a program or database accessed by the electronic communication node 205. Alternatively, such information may be determined by the electronic communication node 205 itself, such as, for example, by scanning the database of records 220 for a particular jurisdiction.

After accessing the database of records 220, the electronic communication node 205 acts to collect from the available data information relating to the parcel of real property according to the request that was inputted via the request signal. This is illustrated in FIG. 1 as Step 110. Preferably, during the collection process, the electronic communication node 205 may perform many specific types of collections. For example, the electronic communication node 205 may merely collect and display the collected information to the end user 230. Most likely, this would occur when the request signal includes a request for a legal description of the parcel, the payment status of real estate (or other) taxes, etc., or similar more simply requests. Additionally, in this step, the electronic communication node may receive real estate tax information regarding the parcel of real property.

Another example of a collection type would be a more extensive collection, requiring an analysis and display of the requested data. Examples of such searches would be directed to obtaining recorder or registrar data, for use in a judgment lien search or litigation search, or for retrieving a document chain relating to the ownership of the parcel.

Preferably, as is the case when determining the method of indexing, the electronic communication node 205 must then determine the local method available for data collection. For instance, the method available for data collection may be by flat files or by data/screen scraping. Having access to the flat files would mean that direct access to the tables of the County database would be available. The data/screen scraping method would be an alternative method of collecting the data when direct access to the tables within the database is unavailable. This unavailability could be for reasons of logistics or security reasons. Through this method, the needed data is collected from predetermined field locations being displayed on a monitor screen which a “snapshot” of that screen is being made.

Additionally the electronic communication node 205 may then open any files within the database necessary for the collection of any data. Such files may include, without limitation, files relating to the executed date of any transfer of the parcel of real property, the recording date of any transfer of the parcel of real property, the parties involved in any transfer of the parcel of real property, the type of document involved, the amount involved and any other details that may be relevant to the transfer of the parcel of real property.

If such a search is requested, then the electronic communication node 205, in Step 115, will then analyze the collected data. Ideally, this analytical process may include at least two steps. In the first step, the documents retrieved (i.e., the collected data) are searched to find deeds of conveyance. In the second step, the documents retrieved are searched for other documents to determine the status of any liens upon the parcel of real property. These “other documents” may include, without limitation, mortgages, trust deeds, assignments of mortgages, assignments of rents, releases, judgments, subordination agreements plats, easements mechanic's lien claims, etc.

All of the data ported to a particular parcel of real property is collected from the earliest data of the database to ensure that no items are inadvertently misused. Once all of the items are collected, the analysis is made to the entire list of data.

In Step 120, the electronic communication node 205 then begins the process of creating the analyzed data report. In this Step, the electronic communication node 205 preferably performs a number of steps.

For example, the electronic communication node 205 places the analyzed documents in a predetermined order, such as, for example, an order based on the recorded date. The electronic communication node 205 then matches related documents and groups them together. An example of this matching may be documents relating to the grant of a mortgage coupled with documents related to the assignment or subsequent release of a mortgage. In such a case, the electronic communication node 205, upon finding the grant of a mortgage (or other lien), will scan the remaining documents for a release. If a release is found, the documents will be so indicated as to not include them in any final report sent to the end user 230. This is because the mortgage has been satisfied and is of no legal consequence at this point. If, however, a release has not been found, the electronic communication will indicate which liens are still unreleased to the end user 230.

At this point, the data collected and analyzed may be presented to an operator. The operator has the ability to review and manually edit the information collected and analyzed. Additionally, at this point, the operator may be able to add additional information prior to the delivery to the end user 230. This may occur if a more structured format is requested by the end user 230. For example, the end user 230, being a title company, may request other information, such as, building setback lines, easements, covenants and restrictions, endorsements, etc.

After completing the analysis on the parcel of property requested in the request signal, the electronic communication node 205 prepares for the delivery and output of the analysis results to the end user 230. This is illustrated in Step 125 of FIG. 1. When this occurs, the electronic communication node 205 may prompt the user for additional information (other than the security code or signal referenced above). For example, it is preferable that the electronic communication node 205 may have set up subscription-based accounts in the name of the end user 230. An account database 225 may store this information. This account would preferably have been set up earlier. The purpose for such accounts would be to charge the accounts with the results to be received. It is contemplated that the end user 230 would pay per result received, although, alternatively, other pay methods may be used (e.g., per page, per time online, etc.). Additionally, it is contemplated that the end user's account would contain other information (i.e., a profile) which would be created in a parameter-based form. Such parameters may include, without limitation, name, address, phone numbers, email addresses or other contact information, type of preferred report, method of delivery, frequency of billing, etc. Preferably, these profiles would be able to be modified. Additionally, the electronic communication node 205 may also provide for an “out of the normal” temporary change to the profile (e.g., a different shipping method).

Delivery of the results, after the analysis report has been formulated, would be instant, and transmitted to the end user 230 in a variety of electronic or non-electronic formats. For example, the analysis report may be part of a properly formatted data stream, ready for use in an end user's database or application. Alternatively, the analysis report may be merged into a text document and transmitted via facsimile, email or other electronic method.

Although meant as only an example of the present invention, the computer source code referenced herein as Appendix A illustrates a preferred embodiment of the present invention of a method and system for outputting an analyzed data report, made in accordance with the present invention.

It should be appreciated that the embodiments described above are to be considered in all respects only illustrative and not restrictive. The scope of the invention is indicated by the following claims rather than by the foregoing description. All changes that come within the meaning and range of equivalents are to be embraced within their scope.

We claim:

1. A method for outputting an analyzed data report, comprising:
receiving a request signal, the request signal being a request for an analyzed data report of a parcel of real property;
accessing a database of records, the database of records relating to the parcel of real property;
collecting data from the database of records;
analyzing the collected data;
creating the analyzed data report from the analysis of the collected data; and
outputting the analyzed data report to an end user.

2. The method of claim 1, wherein the request signal is received at a communication node.

3. The method of claim 2, wherein the request signal is sent by a communication device.

4. The method of claim 1, wherein the collecting step further comprises:
receiving real estate tax information for the parcel of real property;
retrieving a legal description of the parcel of real property;
retrieving a document chain relating to the parcel of real property; and
organizing the data into a predetermined order.

5. The method of claim 1, wherein the analyzing step further comprises:
scanning the collected data;
searching the collected data for a set of preset conditions; and
noting the occurrence of any of the set of preset conditions.

6. The method of claim 1, wherein the creating step further comprises developing the analyzed data report so that the analyzed data report contains a listing of the parcel of real property and any of the set of preset conditions.

7. The method of claim 1, wherein the analyzed data report is outputted according to predetermined preferences.

8. A system for outputting an analyzed data report, comprising:
means for receiving a request signal, the request signal being a request for an analyzed data report of a parcel of real property;
means for accessing a database of records, the database of records relating to the parcel of real property;
means for collecting data from the database of records;
means for analyzing the collected data;
means for creating the analyzed data report from the analysis of the collected data; and
means for outputting the analyzed data report to an end user.

9. The system of claim 8, wherein the request signal is received at a communication node.

10. The system of claim 9, wherein the request signal is sent by a communication device.

11. The system of claim 8, wherein the collecting step further comprises:
means for receiving real estate tax information for the parcel of real property;
means for retrieving a legal description of the parcel of real property;
means for retrieving a document chain relating to the parcel of real property; and
means for organizing the data into a predetermined order.

12. The system of claim 8, wherein the analyzing step further comprises:
means for scanning the collected data;
means for searching the collected data for a set of preset conditions; and
means for noting the occurrence of any of the set of preset conditions.

13. The system of claim 8, wherein the creating step further comprises means for developing the analyzed data report so that the analyzed data report contains a listing of the parcel of real property and any of the set of preset conditions.

14. The system of claim 8, wherein the analyzed data report is outputted according to predetermined preferences.
